(19) United States
(12) Patent Application Publication
(10) Pub. No.: US 2015/0214662 A1
(43) Pub. Date: Jul. 30, 2015

(54) CONNECTOR AFFIXATION STRUCTURE

(71) Applicant: YAZAKI CORPORATION, Tokyo (JP)

(72) Inventors: Takashi Muro, Shizuoka (JP); Masayuki Saitoh, Shizuoka (JP)

(21) Appl. No.: 14/415,778

(22) PCT Filed: Sep. 6, 2013
(86) PCT No.: PCT/JP2013/074146

§ 371 Date: Jan. 20, 2015

(30) Foreign Application Priority Data
Sep. 7, 2012 (JP) 2012-197731

(51) Int. Cl. H01R 13/639

(52) U.S. Cl. CPC H01R 13/639

(57) ABSTRACT

A connector affixation structure including an auxiliary affixation mechanism (40) which abuts against a casing (20) at a position away from a standard affixation mechanism (30) so as to restrain vibration of a connector housing (10). In the auxiliary affixation mechanism (40), a housing affixation portion (41) is provided at one end while a casing abutting portion (42) is provided at the other end. The auxiliary affixation mechanism (40) is formed separately from the connector housing (10). Three auxiliary mechanism mounting portions (51, 52 and 53) are provided in the connector housing (10).

### TECHNICAL FIELD

The present invention relates to a connector affixation structure.

### BACKGROUND ART

In a background-art connector affixation structure shown in FIG. 9, a pair of female and male connector housings 100 and 200 to be connected to each other by fitting are affixed to a flat plate type grounding portion (affixed portion to be affixed) 300 (see Patent Literature 1). The connector affixation structure has a standard affixation mechanism 410 and an auxiliary affixation mechanism 420.

The standard affixation mechanism 410 is a member with which one of the paired connector housings 100 and 200, that is, the connector housing 100 is equipped standardly. A screw-fastening hole portion 411 is formed to penetrate the standard affixation mechanism 410. The standard affixation mechanism 410 is fixed to the grounding portion 300 by a screw member 412 inserted into the hole portion 411. That is, the standard affixation mechanism 410 can affix the connector housing 100 to the grounding portion 300.

The auxiliary affixation mechanism 420 is a member which engages with a mounting hole 302 disposed at a distance from a mounting hole 301 corresponding to the fixed position of the standard affixation mechanism 410 on the grounding portion 300, so that the connector housing 100 can be affixed to the grounding portion 300.

The auxiliary affixation mechanism 420 is formed integrally with the connector housing 100, and provided with a pillar portion 421 which is inserted into the mounting hole 302, and a back-surface abutting portion 422 which protrudes from the tip of the pillar portion 421.

The outer circumferential surface of the pillar portion 421 abuts against the inner circumferential surface of the mounting hole 302 so as to restrain the connector housing 100 from moving (vibrating) in the abutting direction. Thus, the pillar portion 421 serves as a rotation stopper.

The back-surface abutting portion 422 is provided to protrude in a direction perpendicular to the pillar portion 421. The back-surface abutting portion 422 abuts against the back surface of the grounding portion 300 so as to prevent the connector housing 100 from moving (vibrating) in the floating direction which is the abutting direction.

To say other words, the auxiliary affixation mechanism 420 is mounted on the connector housing 100 to abut against the grounding portion and at a distance from the standard affixation mechanism 410 so that the vibration of the connector housing 100 in the abutting direction can be prevented by the abutment against the grounding direction 300.

In the connector affixation structure shown in FIG. 9, when the paired connector housings 100 and 200 connected to each other by fitting are affixed to the grounding portion 300, the affixation strength to the grounding portion 300 is enhanced by the affixation using the auxiliary affixation mechanism 420, so that vibration proof can be prevented from deteriorating due to insufficient affixation strength.

### PRIOR TECHNICAL DOCUMENT

### Patent Document

### Patent Literature 1: JP-A-2010-212137

### SUMMARY OF THE INVENTION

### Problem that the Invention is to Solve

In the aforementioned connector affixation structure, however, the position where the auxiliary affixation mechanism 420 is disposed is fixed. Therefore, when another part (such as a wire harness) is disposed closely to the mounting hole 302 to which the auxiliary affixation mechanism 420 is attached, the auxiliary affixation mechanism 420 may interrupt the part which is close thereto. Further improvement of the attachability should be considered.

In addition, in the aforementioned connector affixation structure, the auxiliary affixation mechanism 420 is mounted to be fixed to the connector housing 100, and the back-surface abutting portion 422 always protrudes outward. Therefore, the auxiliary affixation mechanism 420 may be stained due to interference with another part or the like during storage or transport of the connector housing 100. Thus, management of the connector housing 100 has to be also considered again.

The present invention has been therefore developed in consideration of the aforementioned situation. An object of the invention is to provide a connector affixation structure in which, when a pair of connector housings connected to each other by fitting are affixed to an affixed portion to be affixed, affixation using an auxiliary affixation mechanism enhances affixation strength to the affixed portion, so that vibration proof can be prevented from deteriorating due to insufficient affixation strength, while the attachment direction of the auxiliary affixation mechanism can selected to improve the attachability thereof, and further the auxiliary affixation mechanism can be removed from the connector housings when the auxiliary affixation mechanism is not required, so that the paired connector housings can be managed easily.

### Means for Solving the Problem

The aforementioned object of the invention can be attained by the following configurations.

(1) A connector affixation structure including:

a standard affixation mechanism that is provided in at least one connector housing of a pair of female and male connector housings to be connected to each other by fitting, the standard affixation mechanism affixing the connector housing to an affixed portion to be affixed; and

an auxiliary affixation mechanism that is provided in one connector housing of the pair of female and male connector housings so as to abut against the affixed portion at a position away from the standard affixation mechanism, the auxiliary affixation mechanism restraining vibration of the connector housing in an abutting direction due to abutment against the affixed portion;

wherein the auxiliary affixation mechanism is configured that a housing affixation portion which is fixed to the connector housing is provided at one end while an abutting portion which abuts against the affixed portion is provided at the other end, the auxiliary affixation mechanism being formed separately from the connector housing; and

wherein a plurality of auxiliary mechanism mounting portions are provided in the connector housing to which the auxiliary affixation mechanism is attached, so that an attachment direction of the auxiliary affixation mechanism can be changed.

(2) The connector affixation structure according to the paragraph (1), wherein the housing affixation portion has a structure in which a mounting hole for locking is formed in a central portion of a belt-like portion with a predetermined width and closely to a tip of the belt-like portion so as to penetrate the belt-like portion;

wherein the connector housing to which the auxiliary affixation mechanism is attached is provided with a collective mounting portion including a T-shaped groove on which the belt-like portion can slide in three directions, and a lock protrusion which is formed to rise in an intersection of the T-shaped groove so that the lock protrusion can be fitted into the mounting hole to restrain the belt-like portion from sliding; and

wherein the collective mounting portion serves as a collective structure of three of the auxiliary mechanism mounting portions.

According to the configuration of the aforementioned paragraph (1), the auxiliary affixation mechanism is provided in addition to the standard affixation mechanism. When a pair of connector housings connected to each other by fitting are affixed to a portion to be affixed, affixation using the auxiliary affixation mechanism is performed to enhance the affixation strength to the affixed portion. Thus, the vibration proof can be prevented from deteriorating due to insufficient affixation strength.

In addition, according to the configuration of the aforementioned paragraph (1), a plurality of auxiliary mechanism mounting portions are provided in the connector housing to which the auxiliary affixation mechanism is attached. Accordingly, when the auxiliary mechanism mounting portion to be used is changed, the attachment direction of the auxiliary affixation mechanism can be changed over to a position where the auxiliary affixation mechanism will not interfere with surrounding parts when the auxiliary affixation mechanism is attached. That is, the attachment direction of the auxiliary affixation mechanism can be selected to avoid interference of the auxiliary affixation mechanism with the surrounding parts. Thus, the attachability can be improved.

In addition, according to the configuration of the aforementioned paragraph (1), the auxiliary affixation mechanism is formed separately from the connector housing and designed to be removably attached to the connector housing. Therefore, the auxiliary affixation mechanism may be removed from the connector housing when the auxiliary affixation mechanism is not required, for example, during storage or during transport. Thus, the auxiliary affixation mechanism can be prevented from being stained due to interference with another part or the like, and the paired connector housings can be managed easily.

According to the configuration of the aforementioned paragraph (2), the single lock protrusion disposed in an intersection of the T-shaped groove provided in the collective mounting portion serves as a portion shared among the three auxiliary mechanism mounting portions. Thus, the three auxiliary mechanism mounting portions can be disposed efficiently in a saved space.

In addition, the attachment direction of the auxiliary affixation mechanism can be changed over among three ways. The degree of freedom in changing over the attachment direction is enhanced in accordance with increase in the number of the ways among which the attachment direction can be changed over, for example, as compared with the case where the attachment direction of the auxiliary affixation mechanism can be changed over between two ways. Thus, the attachability can be further improved.

The invention has been described briefly above. When the following description of a mode for carrying out the invention (hereinafter referred to as “embodiment”) is read through with reference to the accompanying drawings, the details of the invention will be made clearer.

### BRIEF DESCRIPTION OF THE DRAWINGS

FIG. 1 is a perspective view of a connector housing having a connector affixation structure according to a first embodiment of the invention, the connector housing being viewed obliquely from above.

FIG. 2 is a perspective view of the connector housing shown in FIG. 1, the connector housing being viewed obliquely from below.

FIG. 3 is a bottom view of the connector housing shown in FIG. 1, which is a view from the arrow A in FIG. 2.

FIG. 4 is a side view of the connector housing shown in FIG. 1, which is a view from the arrow B in FIG. 2.

FIG. 5 is a perspective view of an auxiliary affixation mechanism according to the first embodiment of the invention.

FIG. 6 is a perspective view showing a state in which the connector housing shown in FIG. 1 has been attached to a portion to be affixed.

FIG. 7 is a perspective view of an auxiliary affixation mechanism according to a second embodiment of the invention.

FIG. 8 is a perspective view of a connector housing to which the auxiliary affixation mechanism shown in FIG. 7 has been attached.

FIG. 9 is a perspective view showing a background-art connector affixation structure.

### MODE FOR CARRYING OUT THE INVENTION

Preferred embodiments of a connector affixation structure according to the present invention will be described in detail with reference to the drawings.

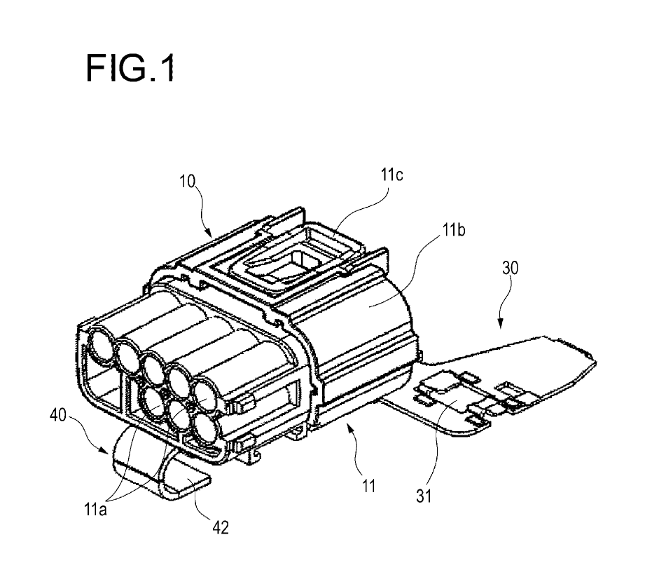

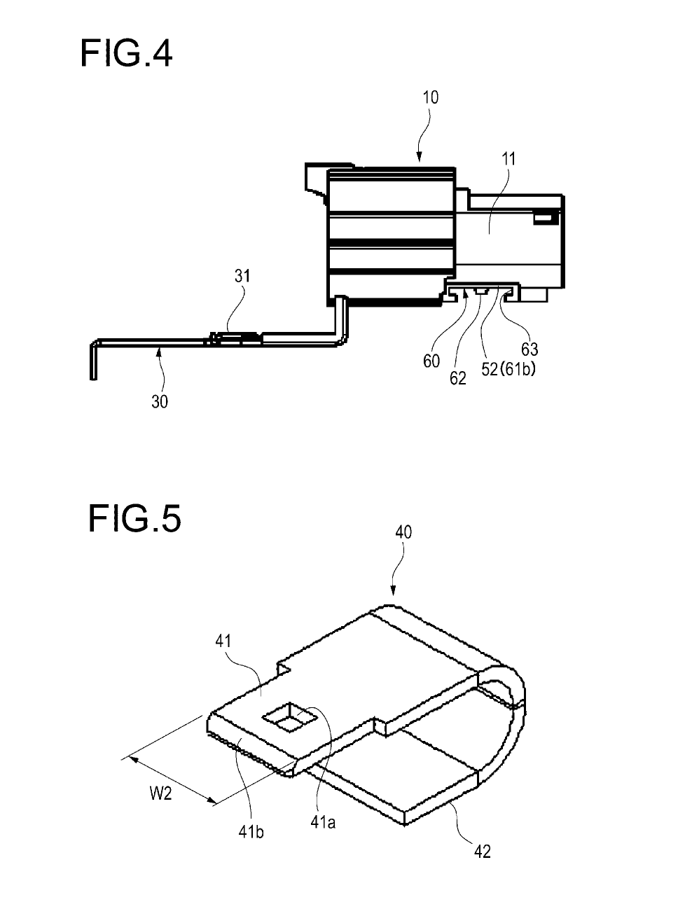

FIGS. 1 to 6 show a connector affixation structure according to the first embodiment of the invention.

A connector housing 10 shown in FIG. 1 is one connector housing of a pair of female and male connector housings to be connected to each other by fitting.

In the connector housing 10, a lock arm 11c for locking another connector housing (not shown) mated by female/male fitting is provided on an upper surface 11b of a housing body 11 including terminal reception holes 11a for receiving not-shown terminal fittings.

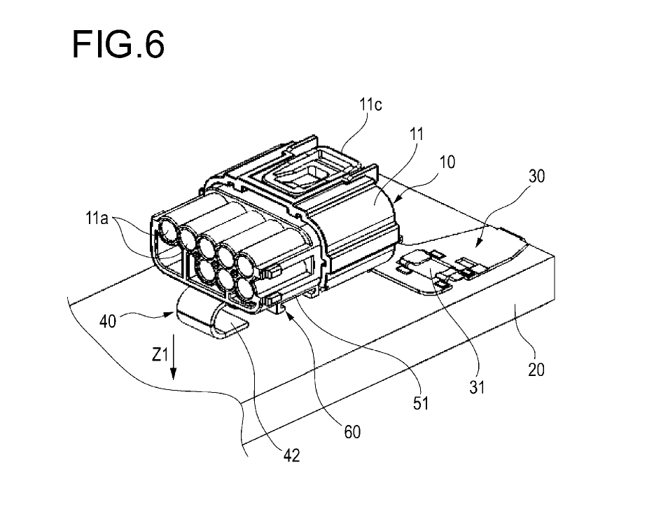

As a connector affixation structure for affixing the connector housing 10 to a casing (portion to be affixed) 20 shown in FIG. 6, a standard affixation mechanism 30, an auxiliary affixation mechanism 40 (see FIG. 5) and three auxiliary mechanism mounting portions 51, 52 and 53 are provided in the connector housing 10.

The standard affixation mechanism 30 is an affixation fitting provided standardly in the connector housing 10. The standard affixation mechanism 30 has a mounting hole 31 for screwing the standard affixation mechanism 30 down to the casing 20. To say other words, the standard affixation mechanism 30 is to affix the connector housing 10 to the casing 20.

In addition, the standard affixation mechanism 30 is fixedly provided in the housing body 11. In addition, the standard affixation mechanism 30 is electrically used as joint terminals conductively connected to a plurality of terminal fittings received in the terminal reception hole 11a.

The auxiliary affixation mechanism 40 is an independent component formed separately from the connector housing 10. As shown in FIG. 5, the auxiliary affixation mechanism 40 has a structure in which a housing affixation portion 41 fixed to the connector housing 10 is provided at one end of the auxiliary affixation mechanism 40 while a casing abutting portion (abutting portion) 42 abutting against the casing 20 is provided at the other end.

In the first embodiment, the auxiliary affixation mechanism 40 has a plate spring structure in which a belt-like plate material is bent into a U shape. One end of the auxiliary affixation mechanism 40 serves as the housing affixation portion 41 while the other end serves as the casing abutting portion 42.

The housing affixation portion 41 according to the first embodiment has a structure in which a mounting hole 41a for locking is formed in a central portion of a belt-like portion 41b with a predetermined width W2 and closely to the tip of the belt-like portion 41b so as to penetrate the belt-like portion 41b.

In the auxiliary affixation mechanism 40 according to the first embodiment, as shown in FIG. 6, the casing abutting portion 42 is provided in the connector housing 10 so as to abut against the casing 20 at a distance from the standard affixation mechanism 30. The auxiliary affixation mechanism 40 serves as a member for restricting vibration of the connector housing 10 in the abutting direction (the arrow Z1 direction in FIG. 6) due to the abutment between the casing abutting portion 42 and the casing 20.

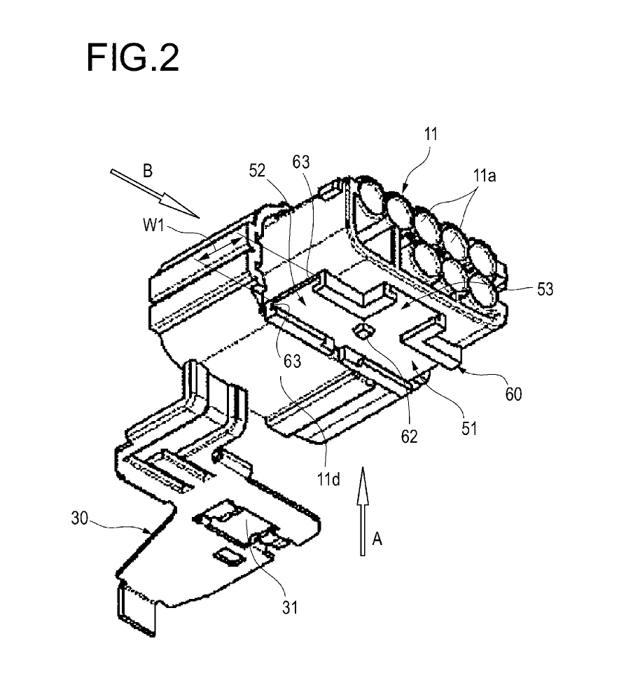

Each of the three auxiliary mechanism mounting portions 51, 52 and 53 according to the first embodiment serves as a portion for fixing the housing affixation portion 41 of the auxiliary affixation mechanism 40. In the first embodiment, as shown in FIG. 2, the three auxiliary mechanism mounting portions 51, 52 and 53 are disposed in a lower surface 11d of the housing body 11 and adjacently to one another. Incidentally, a plurality of auxiliary mechanism mounting portions relating to the connector affixation structure according to the invention are not limited to the three auxiliary mechanism mounting portions 51, 52 and 53. Not to say, it will go well if at least two auxiliary mechanism mounting portions are provided.

In the first embodiment, the three auxiliary mechanism mounting portions 51, 52 and 53 are disposed in different directions from one another so that the auxiliary affixation mechanism 40 can be attached in three different directions.

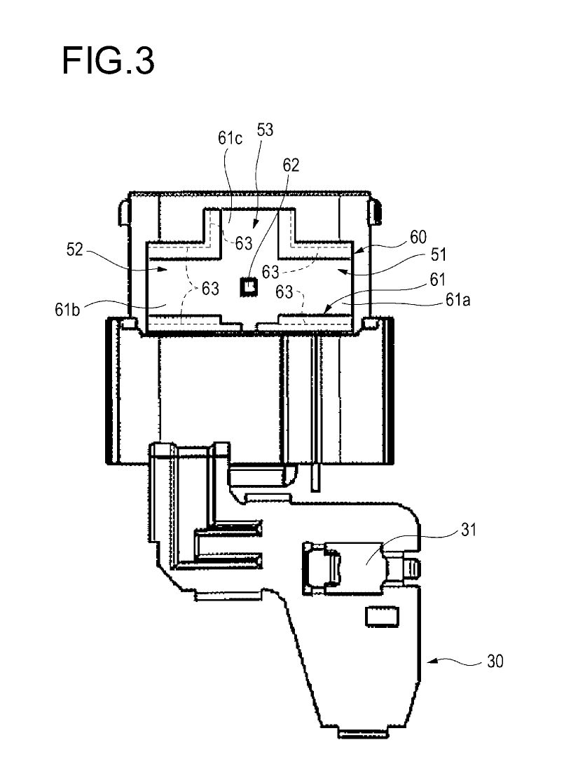

Further in detail, in the first embodiment, a collective mounting portion 60 is formed as a collective structure of the three auxiliary mechanism mounting portions 51, 52 and 53 as shown in FIG. 3.

The collective mounting portion 60 has a T-shaped groove 61 and a lock protrusion 62. The belt-like portion 41b can slide on T-shaped groove 61 in three directions.

The T-shaped groove 61 is formed out of three unit grooves 61a, 61b and 61c constituting the T shape as shown in FIG. 3. Each unit groove 61a, 61b, 61c has a common groove width W1 between a pair of fitting grooves 63 which are formed in the width-direction opposite ends of the unit groove 61a, 61b, 61c so that the belt-like portion 41b can be fitted thereto slidably in the longitudinal direction, as shown in FIG. 2. The groove width W1 of each unit groove 61a, 61b, 61c is large enough for the belt-like portion 41b to be fitted thereto slidably. That is, the relation of W1>W2 is established.

The lock protrusion 62 is a protrusion which is formed to rise at an intersection of the T-shaped groove 61 (an intersection of the center lines of the three unit grooves 61a, 61b and 61c constituting the T shape). The lock protrusion 62 is fitted into the mounting hole 41a of the belt-like portion 41b fitted to one of the unit grooves 61a, 61b and 61c so as to restrain the belt-like portion 41b from sliding.

That is, the collective mounting portion 60 has a collective structure of the three auxiliary mechanism mounting portions 51, 52 and 53, in which the combination of the unit groove 61a and the lock protrusion 62 serves as the first auxiliary mechanism mounting portion 51, the combination of the unit groove 61b and the lock protrusion 62 serves as the second auxiliary mechanism mounting portion 52, and the combination of the unit groove 61c and the lock protrusion 62 serves as the third auxiliary mechanism mounting portion 53.

The connector affixation structure according to the first embodiment described above is provided with the auxiliary affixation mechanism 40 in addition to the standard affixation mechanism 30. When a pair of connector housings connected to each other by fitting are affixed to the casing 20, affixation using the auxiliary affixation mechanism 40 is performed to improve the affixation strength to the casing 20. Thus, the vibration proof can be prevented from deteriorating due to insufficient affixation strength.

In addition, in the connector affixation structure according to the first embodiment, the three auxiliary mechanism mounting portions 51, 52 and 53 are provided in the connector housing 10 to which the auxiliary affixation mechanism 40 is attached. Therefore, when, of the auxiliary mechanism mounting portions 51, 52 and 53, one in use is changed, the attachment direction of the auxiliary affixation mechanism 40 can be changed over to a position where the auxiliary affixation mechanism 40 will not interfere with any other surrounding part when the auxiliary affixation mechanism 40 is attached. That is, the attachment direction of the auxiliary affixation mechanism 40 can be selected to avoid interference of the auxiliary affixation mechanism 40 with the surrounding parts. Thus, the attachability can be improved.

In addition, in the connector affixation structure according to the first embodiment, the auxiliary affixation mechanism 40 is formed separately from the connector housing 10 and designed to be removably attached to the connector housing 10. Therefore, the auxiliary affixation mechanism 40 may be removed from the connector housing 10 when the auxiliary affixation mechanism 40 is not required, for example, during storage or during transport. Thus, the auxiliary affixation mechanism 40 can be prevented from being stained due to interference with another part or the like, and the paired connector housings can be managed easily.

Further, in the connector affixation structure according to the first embodiment, the single lock protrusion 62 disposed in the intersection of the T-shaped groove 61 provided in the collective mounting portion 60 serves as a portion shared among the three auxiliary mechanism mounting portions 51, 52 and 53. Thus, the three auxiliary mechanism mounting portions 51, 52 and 53 can be disposed efficiently in a saved space.

Moreover, the attachment direction of the auxiliary affixation mechanism 40 can be changed over among three ways. The degree of freedom in changing over the attachment direction is enhanced in accordance with increase in the number of the ways among which the attachment direction can be changed over, for example, as compared with the case where the attachment direction of the auxiliary affixation mechanism 40 can be changed over between two ways. Thus, the attachability can be further improved.

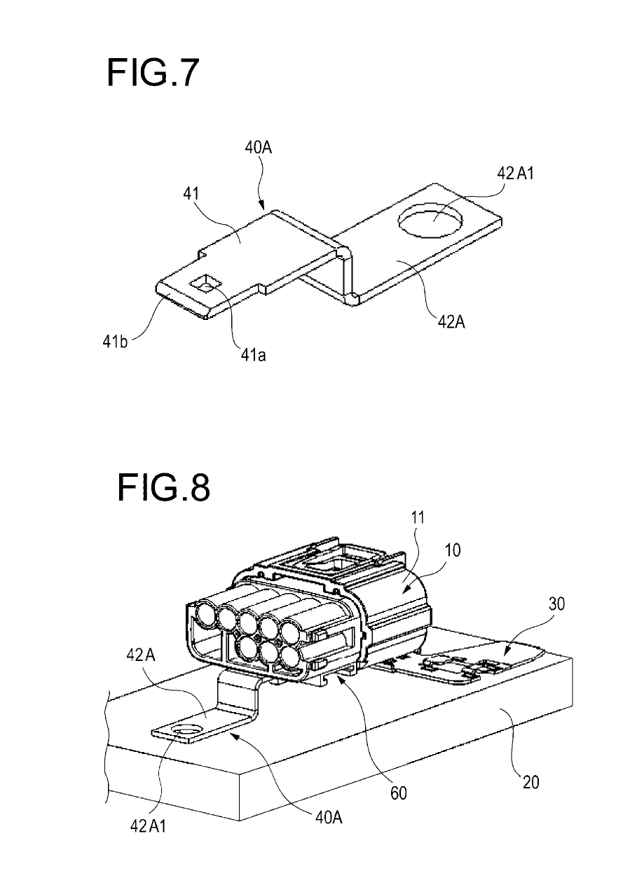

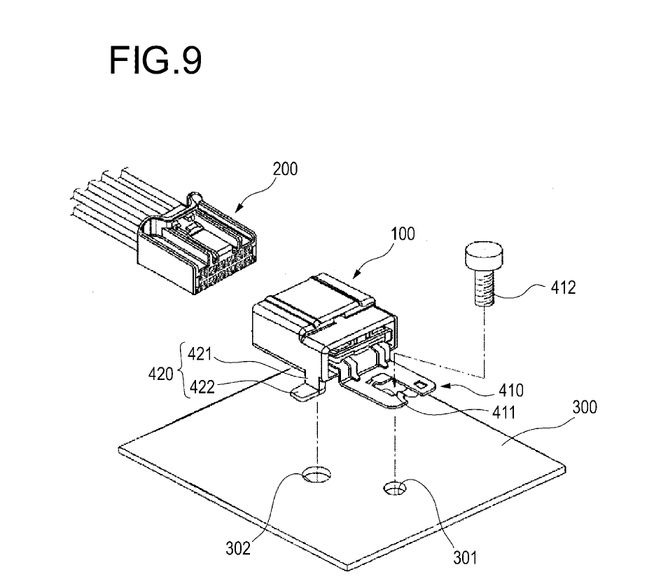

FIG. 7 and FIG. 8 show a connector affixation structure according to the second embodiment of the invention.

In an auxiliary affixation mechanism 40A shown in FIG. 7, a housing affixation portion 41 provided at one end is the same as the housing affixation portion 41 in the first embodiment. A casing abutting portion 42A provided at the other end of the auxiliary affixation mechanism 40A has a hole portion 42A1 to be fixed by a not-shown screw member. Accordingly, since the casing abutting portion 42A abutting against the casing 20 is screwed down, the connector housing 10 in which the auxiliary affixation mechanism 40A according to the second embodiment is attached to the collective mounting portion 60 in place of the auxiliary affixation mechanism 40 according to the first embodiment is fixed more firmly than the casing abutting portion 42 in the first embodiment. Thus, the vibration proof performance can be further enhanced.

The invention is not limited to the aforementioned embodiments, but appropriate modifications, improvements, etc. may be made thereon. In addition, each constituent member in the aforementioned embodiments may have any material, any shape, any dimensions, any number, any installation place, etc. as long as the invention can be carried out.

For example, a plurality of auxiliary mechanism mounting portions do not have to be set as a single collective mounting portion, but may be provided independently of one another. In addition, the specific structure of each auxiliary mechanism mounting portion or the housing affixation portion is not limited to the structure in each aforementioned embodiment, but may be modified in an appropriate design. Further, the affixed portion, to which the connector housings are affixed, is not limited to the casing 20, but various portions to be affixed, such as a circuit board, a vehicle body panel, etc. may be used.

In addition, the number of auxiliary mechanism mounting portions is not limited to the example in each aforementioned embodiment, but it may be set at any number not lower than two. The number of auxiliary mechanism mounting portions may be set at an appropriate number in consideration of suppressing the complication of the structure.

In addition, in the aforementioned embodiments, both the standard affixation mechanism 30 and the auxiliary affixation mechanism 40 are provided in the connector housing 10 which is one of the connector housings. However, the auxiliary affixation mechanism 40 may be provided in the partner connector housing to be connected to the connector housing 10.

Here, the features of the aforementioned embodiments of the connector affixation structure according to the invention can be briefly summed up in the following paragraphs [1] and [2] respectively.

### [1] A Connector Affixation Structure Including:

a standard affixation mechanism (30) that is provided in at least one connector housing (10) of a pair of female and male connector housings to be connected to each other by fitting, the standard affixation mechanism (30) affixing the connector housing (10) to an affixed portion to be affixed (casing) (20); and

an auxiliary affixation mechanism (40) that is provided in one connector housing (10) of the pair of female and male connector housings so as to abut against the affixed portion (20) at a position away from the standard affixation mechanism (30), the auxiliary affixation mechanism (40) restraining vibration of the connector housing (10) in an abutting direction due to abutment against the affixed portion (20); wherein:

the auxiliary affixation mechanism (40) is configured that a housing affixation portion (41) which is fixed to the connector housing (10) is provided at one end while an abutting portion (casing abutting portion) (42) which abuts against the affixed portion (casing) (20) is provided at the other end, the auxiliary affixation mechanism (40) being formed separately from the connector housing (10); and

wherein a plurality of auxiliary mechanism mounting portions (51, 52 and 53) are provided in the connector housing (10) to which the auxiliary affixation mechanism (40) is attached, so that an attachment direction of the auxiliary affixation mechanism (40) can be changed.

[2] The connector affixation structure according to the paragraph (1), wherein the housing affixation portion (41) has a structure in which a mounting hole (41a) for locking is formed in a central portion of a belt-like portion (41b) with a predetermined width and closely to a tip of the belt-like portion (41b) so as to penetrate the belt-like portion (41b);

wherein the connector housing (10) to which the auxiliary affixation mechanism (40) is attached is provided with a collective mounting portion (60) including a T-shaped groove (61) on which the belt-like portion (41b) can slide in three directions, and a lock protrusion (62) which is formed to rise in an intersection of the T-shaped groove (61) so that the lock protrusion (62) can be fitted into the mounting hole (41a) to restrain the belt-like portion (41b) from sliding; and

wherein the collective mounting portion (60) serves as a collective structure of three of the auxiliary mechanism mounting portions (51, 52 and 53).

The present application is based on a Japanese patent application (Patent Application No. 2012-197731) filed on Sep. 7, 2012, the contents of which will be incorporated herein by reference.

### INDUSTRIAL APPLICABILITY

According to a connector affixation structure according to the invention, when a pair of connector housings connected to each other by fitting are affixed to a portion to be affixed, the affixation strength to the affixed portion is enhanced by affixation using an auxiliary affixation mechanism, so that vibration proof can be prevented from deteriorating due to insufficient affixation strength. In addition, the attachment direction of the auxiliary affixation mechanism can be selected to improve the attachability. Further, the auxiliary affixation mechanism can be removed from the connector housings when the auxiliary affixation mechanism is not required. Thus, the paired connector housings can be managed easily.

### DESCRIPTION OF REFERENCE NUMERALS AND SIGNS

10 connector housing
20 casing (portion to be affixed)
30 standard affixation mechanism
40 auxiliary affixation mechanism
41 housing affixation portion
41a mounting hole
41b belt-like portion
42 casing abutting portion (abutting portion)
51,52,53 auxiliary mechanism mounting portion
60 collective mounting portion
61 T-shaped groove
62 lock protrusion

1. A connector affixation structure comprising:
a standard affixation mechanism that is provided in at least one connector housing of a pair of female and male connector housings to be connected to each other by fitting, the standard affixation mechanism affixing the connector housing to an affixed portion to be affixed; and
an auxiliary affixation mechanism that is provided in one connector housing of the pair of female and male connector housings so as to abut against the affixed portion at a position away from the standard affixation mechanism, the auxiliary affixation mechanism restraining vibration of the connector housing in an abutting direction due to abutment against the affixed portion,
wherein the auxiliary affixation mechanism is configured that a housing affixation portion which is fixed to the connector housing is provided at one end while an abutting portion which abuts against the affixed portion is provided at the other end, the auxiliary affixation mechanism being formed separately from the connector housing; and
wherein a plurality of auxiliary mechanism mounting portions are provided in the connector housing to which the auxiliary affixation mechanism is attached, so that an attachment direction of the auxiliary affixation mechanism can be changed.

2. The connector affixation structure according to claim 1, wherein the housing affixation portion has a structure in which a mounting hole for locking is formed in a central portion of a belt-like portion with a predetermined width and closely to a tip of the belt-like portion so as to penetrate the belt-like portion;
wherein the connector housing to which the auxiliary affixation mechanism is attached is provided with a collective mounting portion including a T-shaped groove on which the belt-like portion can slide in three directions, and a lock protrusion which is formed to rise in an intersection of the T-shaped groove so that the lock protrusion can be fitted into the mounting hole to restrain the belt-like portion from sliding; and
wherein the collective mounting portion serves as a collective structure of three of the auxiliary mechanism mounting portions.
